(19) United States
(12) Patent Application Publication
(10) Pub. No.: US 2026/0203237 A1
(43) Pub. Date: Jul. 16, 2026

(54) Server System Component Fabric Manager System

(71) Applicant: Dell Products L.P., Round Rock, TX (US)

(72) Inventors: Michael Griffith, Round Rock, TX (US); Owen Kidd, Cedar Park, TX (US)

(21) Appl. No.: 19/019,864

(22) Filed: Jan. 14, 2025

(51) Int. Cl. G06F 13/40; H04L 49/253

(52) U.S. Cl. CPC G06F 13/4022; H04L 49/254; G06F 2213/0026

(57) ABSTRACT

A component system for use with an information handling system. The component system includes an array of components; and, a fabric manager system, the fabric manager system comprising: a baseboard component, the baseboard component comprising a printed circuit board and a plurality of switch elements; and, a fabric manager component communicating with the baseboard component, the fabric manager component comprising: a circuit board, the board comprising a printed circuit board; a switching element mounted on the circuit board; and a plurality of high speed input/output connectors mounted on the board, the plurality of high speed input/output connectors being coupled to the switching element, the switching element and the plurality of high speed connectors being configured to enable the fabric manager component to function as an arbitrator for peer-to-peer traffic between other switch devices of the information handling system.

### BACKGROUND OF THE INVENTION

### Field of the Invention

The present invention relates to information handling systems. More specifically, embodiments of the invention relate to server type information handling systems within information technology (IT) environments.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to use information handling systems and related IT systems within information technology (IT) environments such as data centers.

### SUMMARY OF THE INVENTION

A system and method for providing a server system with a component system fabric manager system.

In one embodiment, the invention relates to a fabric manager component of a fabric manager system for an information handling system, comprising: a circuit board, the board comprising a printed circuit board; a switching element mounted on the circuit board; and a plurality of high speed input/output connectors mounted on the board, the plurality of high speed input/output connectors being coupled to the switching element, the switching element and the plurality of high speed connectors being configured to enable the fabric manager component to function as an arbitrator for peer-to-peer traffic between other switch devices of the information handling system.

In another embodiment, the invention relates to a component system for use in an information handling system comprising: an array of components, the array of components comprising a plurality of components; and a fabric manager system, the fabric manager system comprising: a baseboard component, the baseboard component comprising a printed circuit board and a plurality of switch elements; and a fabric manager component communicating with the baseboard component, the fabric manager component comprising: a circuit board, the board comprising a printed circuit board; a switching element mounted on the circuit board; and a plurality of high speed input/output connectors mounted on the board, the plurality of high speed input/output connectors being coupled to the switching element, the switching element and the plurality of high speed connectors being configured to enable the fabric manager component to function as an arbitrator for peer-to-peer traffic between other switch devices of the information handling system.

In another embodiment, the invention relates to a system comprising: a chassis; a processor contained within the chassis; a data bus coupled to the processor; an array of components, the array of components comprising a plurality of components; and, a fabric manager system, the fabric manager system comprising: a baseboard component, the baseboard component comprising a printed circuit board and a plurality of switch elements; and, a fabric manager component communicating with the baseboard component, the fabric manager component comprising: a circuit board, the board comprising a printed circuit board; a switching element mounted on the circuit board; and a plurality of high speed input/output connectors mounted on the board, the plurality of high speed input/output connectors being coupled to the switching element, the switching element and the plurality of high speed connectors being configured to enable the fabric manager component to function as an arbitrator for peer-to-peer traffic between other switch devices of the information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a perspective view of a portion of a data center within an IT environment.

FIG. 3 shows a generalized perspective view of an example server type information handling system.

FIG. 4 shows a top view of a fabric manager component.

FIG. 5 shows a top view of a component system having a fabric manager system.

FIGS. 6A and 6B, generally referred to as FIG. 6, show schematic views of a component system having a fabric manager system.

FIGS. 7A and 7B, generally referred to as FIG. 7, show diagrammatic views of an information handling system chassis having a component system.

FIG. 8 shows a diagrammatic view of a plurality of information handling system chassis having respective component systems.

### DETAILED DESCRIPTION

Various aspects of the present disclosure include an appreciation that it is known to provide information handling systems with a plurality of components. Various aspects of the present disclosure include an appreciation that graphics processing unit (GPU) modules are one example of a component that is included within an information handling system. Various aspects of the present disclosure include an appreciation that it may be desirable to provide an information handling system with an array of components. Various aspects of the present disclosure include an appreciation that it may be desirable to install an array of GPU modules within an information handling system.

Various aspects of the present disclosure include an appreciation that GPU modules are often configured to conform to form factor standards. Various aspects of the present disclosure include an appreciation that the peripheral component interconnect express (PCIe) card electromechanical (CEM) form factor standard is one such form factor standard.

Various aspects of the disclosure include an appreciation that it is known to provide information handling systems with baseboard components such as peripheral component interconnect express (PCIe) type baseboard components. Various aspects of the disclosure include an appreciation that it is known to provide baseboard components which function as a processor to PCIe switch. Various aspects of the present disclosure include an appreciation that with certain component configurations, it can be advantageous to provide high speed input/output (HSIO) connections to a plurality of components via circuits mounted on the baseboard component. Various aspects of the present disclosure include an appreciation that with certain CEM GPU module configurations, it can be advantageous to provide HSIO connections to the GPU modules via circuits mounted on the baseboard component.

Various aspects of the present disclosure include an appreciation that with certain CEM GPU module configurations, it can be advantageous to provide point-to-point connections between multiple GPU modules contained in the system. Various aspects of the present disclosure include an appreciation that the point-to-point GPU module to GPU module connections may conform to certain GPU interconnect specifications such as the NVLink interconnection specification or the UALink specification.

Various aspects of the present disclosure include an appreciation that known HSIO connection topologies often rely upon vendor-specific device interlinks for maximum point to point (P2P) interconnectivity. Various aspects of the present disclosure include an appreciation that often the vendor-specific device interlinks do not apply to all available components and are often proprietary. Various aspects of the present disclosure include an appreciation that known HSIO connection topologies may also rely on unbalanced inter-switch links. Various aspects of the present disclosure include an appreciation that unbalanced inter-switch links can consume PCIe lanes from the switch topology. Various aspects of the present disclosure include an appreciation that unbalanced inter-switch links often cannot accomplish an all-to-all connection between peer devices (e.g., peer components).

Various aspects of the present disclosure include an appreciation that it would be desirable to provide an HSIO connection topology with an additional switching element. Various aspects of the present disclosure include an appreciation that it would be desirable to configure the additional switching element as an arbitrator for peer-to-peer traffic between other switch devices contained within the host platform.

A system and method are disclosed for providing an information handling system with a component system which includes plurality of components and a fabric manager system. In certain embodiments, the fabric manager system includes a fabric manager component. In certain embodiments, the fabric manager component is configured as a PCIe fabric manager.

In certain embodiments, the fabric manager system is organized in a tree topology, while performing as a mesh connected topology. In certain embodiments, the fabric manager component is configured as an additional circuit board which includes a switching element, a plurality of input and output HSIO connections, a fabric manager component power input, or a combination thereof. In certain embodiments, the fabric manager component also includes a heatsink for cooling the additional components. In certain embodiments, the switching element provides a component HSIO topology with a fifth switching element. In certain embodiments, the plurality of input and output HSIO connections are design dependent.

In certain embodiments, the information handling system chassis is configured to provide a location to mechanically house the fabric manager component. In certain embodiments, the fabric manager system includes cables for routing communication to and from the fabric manager component. In certain embodiments, the information handling system chassis is configured to provide a location to mechanically route the cables to and from the fabric manager component.

In certain embodiments, the fabric manager component may be configured to operate solely as an internal point to point traffic manager. In certain embodiments, the fabric manager component may be configured to operate in a multi-host environment where two or more information handling systems communicate via respective fabric manager components.

In certain embodiments, the information handling system may be configured to function with or without the fabric manager system depending on whether additional point to point functionality is needed by a particular design. In certain embodiments, the fabric manager system may be implemented as a PCIe tree topology, as a standalone HSIO switch device, or a combination thereof.

In certain embodiments, the fabric manager component functions as an arbitrator for peer-to-peer traffic between other switch devices of the host platform. In certain embodiments, the fabric manager component consumes fewer PCIe links than an unbalanced inter-switch link. In certain embodiments, the fabric manager component is implemented as an optional board which only adds cost to system configurations that need it.

In certain embodiments, the fabric manager system functions universally on designs from supporting switch vendors that use a plurality of PCIe switch devices. In certain embodiments, the fabric manager system functions universally on designs from supporting switch vendors that use two or more PCIe switch devices. In certain embodiments, the fabric manager system provides a hybrid switch topology which includes a fabric manager component and one or more PCIe switch devices. In certain embodiments, the fabric manager system allows dedicated PCIe inter switch linking.

Such a fabric manager system advantageously provides a switch topology with increased flexibility for balanced peer to peer communication between a variety of third party accelerators. Such a fabric manager system advantageously provides an HSIO connection topology with an additional switching element. Such a fabric manager system advantageously provides an ability to configure an additional switching element as an arbitrator for peer-to-peer traffic between other switch devices contained within the host platform. Such a fabric manager system advantageously provides additional PCIe lanes for custom platform configuration requests applicable to information handling system platforms using two or more PCIe switches.

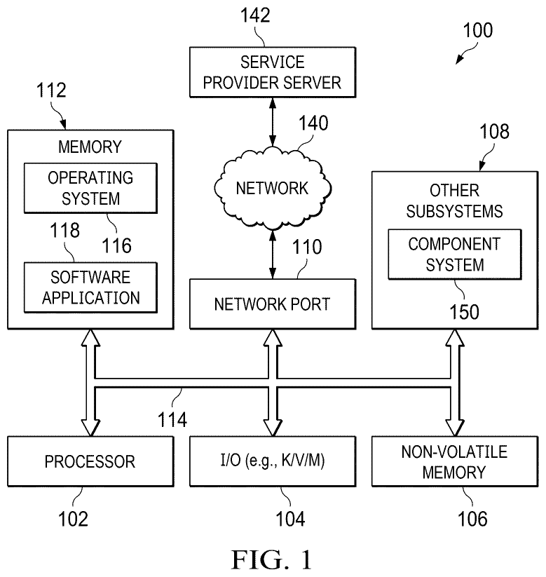

FIG. 1 shows a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. In various embodiments, the other subsystems 108 include a component system 150. The information handling system 100 likewise includes system memory 112, which is interconnected to the foregoing via one or more buses 114. System memory 112 further comprises operating system (OS) 116 and a software application 118. In certain embodiments, the information handling system 100 is one of a plurality of information handling systems within a data center. In certain embodiments, the information handling system 100 comprises a server type information handling system. In certain embodiments, the server type information handling system is configured to be mounted within a server rack. In certain embodiments, the other subsystem 108 includes one or more power supplies for supplying power to the other components of the information handling system 100.

In certain embodiments, the information handling system 100 comprises a server type information handling system. In certain embodiments, the server type information handling system comprises a blade server type information handling system. As used herein, a blade server type information handling system broadly refers to an information handling system which is physically configured to be mounted within a server rack.

In certain embodiments, the component system 150 includes a plurality of components, a fabric manager system, or a combination thereof. In certain embodiments, the fabric manager system includes a fabric manager component. In certain embodiments, the fabric manager component is configured as a PCIe fabric manager. In certain embodiments, the fabric manager system is organized in a tree topology, while performing as a mesh connected topology. In certain embodiments, with the mesh connected topology, every node within the topology can communicate with every other node in the topology. In certain embodiments, the fabric manager component is configured as an additional circuit board which includes a switching element, a plurality of input and output HSIO connections, a fabric manager component power input, or a combination thereof. In certain embodiments, the fabric manager component also includes a heatsink for cooling the additional components. In certain embodiments, the switching element provides a component HSIO topology with a fifth switching element. In certain embodiments, the plurality of input and output HSIO connections are design dependent.

In certain embodiments, the information handling system chassis is configured to provide a location to mechanically house the fabric manager component. In certain embodiments, the fabric manager system includes cables for routing communication to and from the fabric manager component. In certain embodiments, the information handling system chassis is configured to provide a location to mechanically route the cables to and from the fabric manager component.

In certain embodiments, the fabric manager component may be configured to operate solely as an internal point to point traffic manager. In certain embodiments, the fabric manager component may be configured to operate in a multi-host environment where two or more information handling systems communicate via respective fabric manager components.

In certain embodiments, the information handling system 100 may be configured to function with or without the fabric manager system depending on whether additional point to point functionality is needed by a particular design. In certain embodiments, the fabric manager system may be implemented as a PCIe tree topology, as a standalone HSIO switch device, or a combination thereof.

In certain embodiments, the fabric manager component functions as an arbitrator for peer-to-peer traffic between other switch devices of the host platform. In certain embodiments, the fabric manager component consumes fewer PCIe links than an unbalanced inter-switch link. In certain embodiments, the fabric manager component implemented as an optional board which only adds cost to system configurations that need it.

In certain embodiments, the fabric manager system functions universally on designs from supporting switch vendors that use a plurality of PCIe switch devices. In certain embodiments, the fabric manager system functions universally on designs from supporting switch vendors that use two or more PCIe switch devices. In certain embodiments, the fabric manager system provides a hybrid switch topology which includes a fabric manager component and one or more PCIe switch devices. In certain embodiments, the fabric manager system allows dedicated PCIe inter switch linking.

Such a fabric manager system advantageously provides a switch topology with increased flexibility for balanced peer to peer communication between a variety of third party accelerators. Such a fabric manager system advantageously provides an HSIO connection topology with an additional switching element. Such a fabric manager system advantageously provides an ability to configure an additional switching element as an arbitrator for peer-to-peer traffic between other switch devices contained within the host platform. Such a fabric manager system advantageously provides additional PCIe lanes for custom platform configuration requests applicable to information handling system platforms using two or more PCI-e switches.

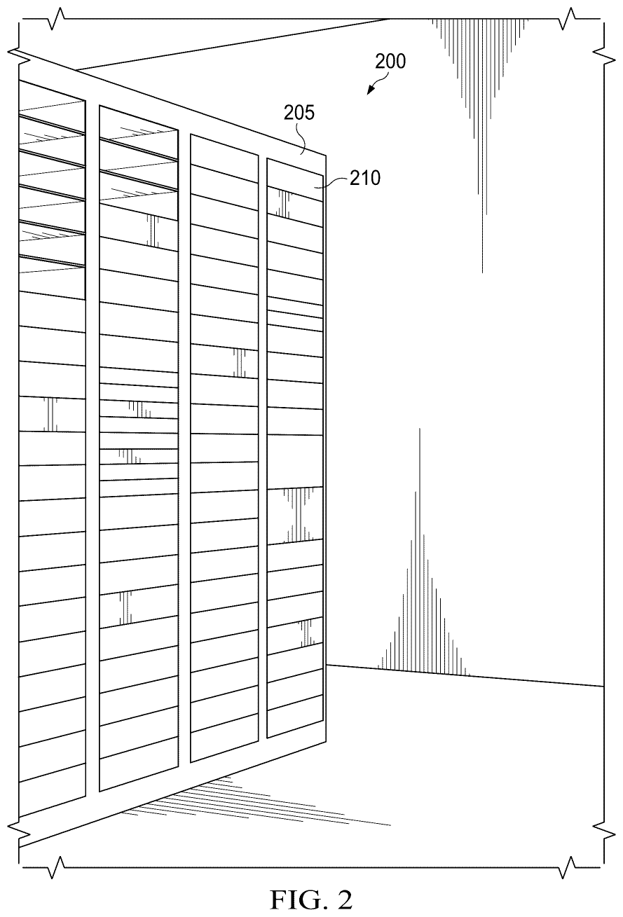

FIG. 2 shows a perspective view of a portion of an IT environment 200. The IT environment includes one or more racks 205 which include a plurality of information handling systems 100, often referred to as a server rack. In various embodiments, the IT environment 200 comprises a data center. As used herein, a data center refers to an IT environment which includes a plurality of networked information handling systems 100. In various embodiments, the information handling systems 100 of the data center include some or all of router type information handling systems, switch type information handling systems, firewall type information handling systems, storage system type information handling systems, server type information handling systems and application delivery controller type information handling systems. In certain environments, the information handling systems 100 are mounted within respective racks. As used herein, a rack refers to a physical structure that is designed to house the information handling systems 100, as well as the associated cabling and power provision for the information handling systems. In certain embodiments, a rack includes side panels to which the information handling systems are mounted. In certain embodiments, the rack includes a top panel and a bottom panel to which the side panels are attached. In certain embodiments, the side panels each include a front side panel and a rear side panel.

In certain embodiments, a plurality of racks is arranged continuous with each other to provide a rack system. An IT environment can include a plurality of rack systems arranged in rows with aisles via which IT service personnel can access information handling systems mounted in the racks. In certain embodiments, the aisles can include front aisles via which the front of the information handling systems may be accessed and hot aisles via which the infrastructure (e.g., data and power cabling) of the IT environment can be accessed.

Each respective rack includes a plurality of vertically arranged information handling systems 210. In certain embodiments, the information handling systems may conform to one of a plurality of standard server sizes. In certain embodiments, the plurality of server sizes conforms to particular rack unit sizes (i.e., rack units). As used herein, a rack unit broadly refers to a standardized server system height. As is known in the art, a server system height often conforms to one of a 1U rack unit, a 2U rack unit, and a 4U rack unit. In general, a 1U rack unit is substantially (i.e., +/−20%) 1.75″ high, a 2U rack unit is substantially (i.e., +/−20%) 3.5″ high, and a 4U rack height is substantially (i.e., +/−20%) 7.0″ high.

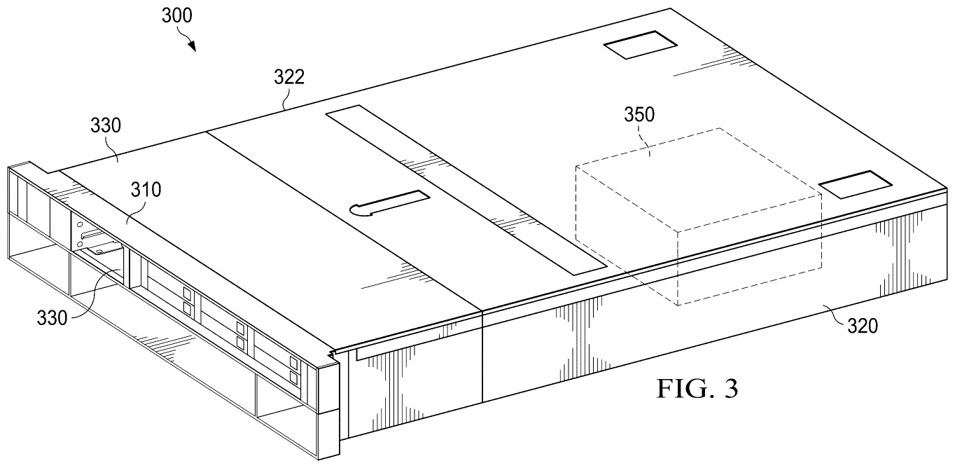

FIG. 3 shows a generalized perspective view of an example blade server type information handling system 300. In certain embodiments, the server type information handling system includes a front portion 310, which is accessible when the server type information handing system 300 is mounted on a server rack. In certain embodiments, the side portions 320, 322 mount to the rack via respective server mounting components. In certain embodiments, the side portions mount to the rack via respective mechanical guiding features which are mechanically coupled to respective server mounting components. In certain embodiments, the server type information handling system can slide out from the rack via the respective mechanical guiding features. In certain embodiments, internal components of the blade type information handling system 300 may be accessed by removing a top panel 330 of the blade type information handing system 300.

In certain embodiments, the blade type information handing system 300 includes a component system 350. In certain embodiments, the component system 350 corresponds to component system 350.

In certain embodiments, the component system 350 includes a plurality of components, a fabric manager system, or a combination thereof. In certain embodiments, the fabric manager system includes a fabric manager component. In certain embodiments, the fabric manager component is configured as a PCIe fabric manager. In certain embodiments, the fabric manager system is organized in a tree topology, while performing as a mesh connected topology. In certain embodiments, with the mesh connected topology, every node within the topology can communicate with every other node in the topology. In certain embodiments, the fabric manager component is configured as an additional circuit board which includes a switching element, a plurality of input and output HSIO connections, a fabric manager component power input, or a combination thereof. In certain embodiments, the fabric manager component also includes a heatsink for cooling the additional components. In certain embodiments, the switching element provides a component HSIO topology with a fifth switching element. In certain embodiments, the plurality of input and output HSIO connections are design dependent.

In certain embodiments, the information handling system chassis is configured to provide a location to mechanically house the fabric manager component. In certain embodiments, the fabric manager system includes cables for routing communication to and from the fabric manager component. In certain embodiments, the information handling system chassis is configured to provide a location to mechanically route the cables to and from the fabric manager component.

In certain embodiments, the fabric manager component may be configured to operate solely as an internal point to point traffic manager. In certain embodiments, the fabric manager component may be configured to operate in a multi-host environment where two or more information handling systems communicate via respective fabric manager components.

In certain embodiments, the information handling system 100 may be configured to function with or without the fabric manager system depending on whether additional point to point functionality is needed by a particular design. In certain embodiments, the fabric manager system may be implemented as a PCIe tree topology, as a standalone HSIO switch device, or a combination thereof.

In certain embodiments, the fabric manager component functions as an arbitrator for peer-to-peer traffic between other switch devices of the host platform. In certain embodiments, the fabric manager component consumes fewer PCIe links than an unbalanced inter-switch link. In certain embodiments, the fabric manager component implemented as an optional board which only adds cost to system configurations that need it.

In certain embodiments, the fabric manager system functions universally on designs from supporting switch vendors that use a plurality of PCIe switch devices. In certain embodiments, the fabric manager system functions universally on designs from supporting switch vendors that use two or more PCIe switch devices. In certain embodiments, the fabric manager system provides a hybrid switch topology which includes a fabric manager component and one or more PCIe switch devices. In certain embodiments, the fabric manager system allows dedicated PCIe inter switch linking.

Such a fabric manager system advantageously provides a switch topology with increased flexibility for balanced peer to peer communication between a variety of third party accelerators. Such a fabric manager system advantageously provides an HSIO connection topology with an additional switching element. Such a fabric manager system advantageously provides an ability to configure an additional switching element as an arbitrator for peer-to-peer traffic between other switch devices contained within the host platform. Such a fabric manager system advantageously provides additional PCIe lanes for custom platform configuration requests applicable to information handling system platforms using two or more PCI-e switches.

In certain embodiments, the component system 350 provides a component array system. In certain embodiments, the component array includes a GPU module array. In certain embodiments, a GPU module array system includes a fabric manager system and a GPU module array. In certain embodiments, the component system includes a baseboard component. In certain embodiments, the baseboard component includes a plurality of connectors. In certain embodiments, the plurality of connectors includes respective PCIe type connectors.

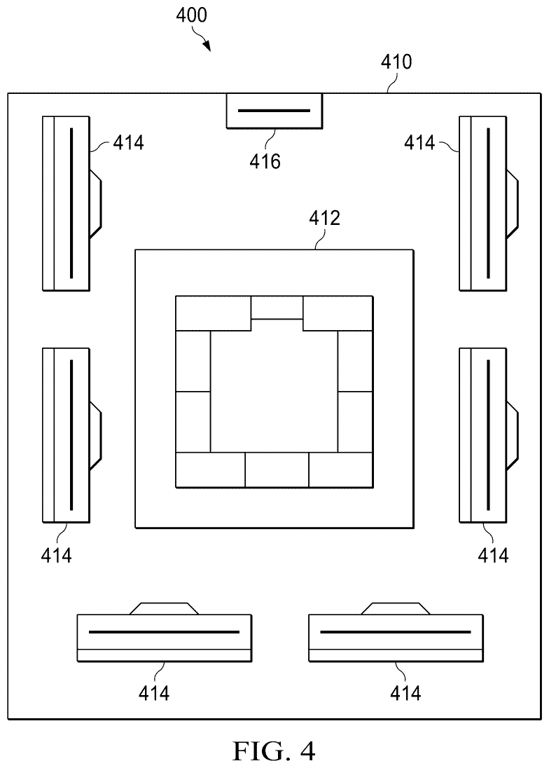

FIG. 4 shows a top view of a fabric manager component 400. In certain embodiments, the fabric manager component 400 corresponds to the fabric manager component of component system 150. In certain embodiments, the fabric manager component 400 allows the fabric manager system to be organized in a tree topology implementation, while performing as a mesh connected topology. In certain embodiments, with the mesh connected topology, every node within the topology can communicate with every other node in the topology. In certain embodiments, the fabric manager component is configured as an additional component which communicates with a baseboard of the fabric manager system. In certain embodiments, the fabric manager component 400 functions as an arbitrator for peer-to-peer traffic between other switch devices of the host platform. In certain embodiments, the fabric manager component 400 consumes fewer PCIe links than an unbalanced inter-switch link. In certain embodiments, the fabric manager component 400 is implemented as an optional board which only adds cost to system configurations that need it.

In certain embodiments, the fabric manager component 400 includes a circuit board 410, a switching element 412, a plurality of HSIO connectors 414, a fabric manager component power input 416, or a combination thereof. In certain embodiments, the fabric manager component also includes a heatsink (not shown) for cooling the additional components. In certain embodiments, the switching element 412 is physically and electrically coupled to the circuit board 410. In certain embodiments, each of the plurality of HSIO connectors 414 is physically and electrically coupled to the circuit board 410. In certain embodiments, fabric manager component power input 416 is physically and electrically coupled to the circuit board 410.

In certain embodiments, the switching element 412 includes a multi-link switch component. In certain embodiments, the switching element 412 includes a multi-lane switch. In certain embodiments, the multi-link switch component includes nine switch stations, each having sixteen lanes, which provides a 144-lane switch. In certain embodiments, the multi-link switch component includes a multi-lane PCIe switch. In certain embodiments, the multi-lane PCIe switch includes a 144-lane PCIe switch. In certain embodiments, the multi-lane PCIe switch includes nine switch stations, each having sixteen lanes, which provides a 144-lane PCIe switch.

In certain embodiments, the plurality of HSIO connectors 414 are positioned along peripheral edges of the circuit board 410. In certain embodiments, two HSIO connectors 414 are positioned along first peripheral edge of the circuit board 410. In certain embodiments, two HSIO connectors 414 are positioned along second peripheral edge of the circuit board 410. In certain embodiments, two HSIO connectors 414 are positioned along third peripheral edge of the circuit board 410. In certain embodiments, the plurality of HSIO connectors 414 include a plurality of HSIO switch connectors, a plurality of HSIO host connectors, or a combination thereof. In certain embodiments, a HSIO host connector and a HSIO switch connector are positioned along first peripheral edge of the circuit board 410. In certain embodiments, two HSIO switch connectors are positioned along second peripheral edge of the circuit board 410. In certain embodiments, a HSIO host connector and a HSIO switch connector are positioned along third peripheral edge of the circuit board 410.

In certain embodiments, each of the plurality of HSIO switch connectors is configured to connect the fabric manager component 400 to a respective HSIO switch. In certain embodiments, each respective HSIO switch is associated with one or more components of the component system. In certain embodiments, each respective HSIO switch is associated with four components of the component system. In certain embodiments, each of the plurality of HSIO host connectors is configured to connect the fabric manager component 400 to a respective host connector.

In certain embodiments, the plurality of HSIO connectors includes a first HSIO switch connector, a second HSIO switch connector, a third HSIO switch connector and a fourth HSIO switch connector. In certain embodiments, the first HSIO switch connector is configured to connect the fabric manager component 400 to a first HSIO switch. In certain embodiments, the second HSIO switch connector is configured to connect the fabric manager component 400 to a second HSIO switch. In certain embodiments, the third HSIO switch connector is configured to connect the fabric manager component 400 to a third HSIO switch. In certain embodiments, the fourth HSIO switch connector is configured to connect the fabric manager component 400 to a fourth HSIO switch.

In certain embodiments, the plurality of HSIO host connectors 414 include a first HSIO host connector and a second HSIO host connector. In certain embodiments, the first HSIO host connector is configured to connect the fabric manager component 400 to a first HSIO host component. In certain embodiments, the second HSIO host connector is configured to connect the fabric manager component 400 to a second HSIO host component. In certain embodiments, the first host component and the second host component include respective processors.

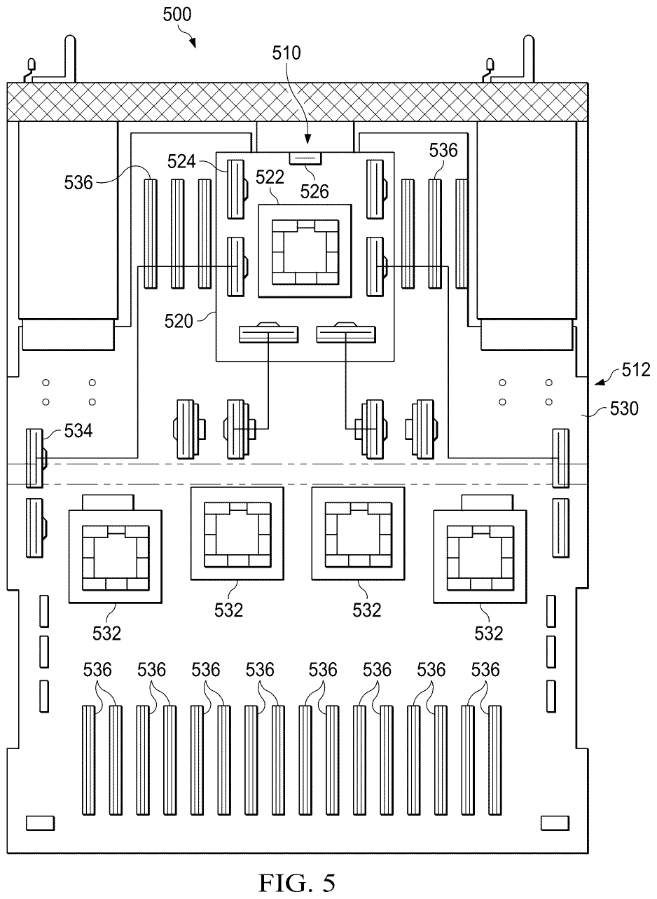

FIG. 5 shows a top view of a fabric manager system 500. In certain embodiments, the fabric manager system 500 corresponds to the fabric manager system of component system 150. In certain embodiments, the fabric manager system 500 is organized in a tree topology implementation, while performing as a mesh connected topology. In certain embodiments, with the mesh connected topology, every node within the topology can communicate with every other node in the topology. In certain embodiments, the fabric manager system 500 functions universally on designs from supporting switch vendors that use a plurality of PCIe switch devices. In certain embodiments, the fabric manager system 500 functions universally on designs from supporting switch vendors that use four or more PCIe switch devices. In certain embodiments, the fabric manager system 500 provides a hybrid switch topology. In certain embodiments, the fabric manager system 500 allows dedicated PCIe inter switch linking.

In certain embodiments, the fabric manager system includes a fabric manager component 510, a baseboard component 512, or a combination thereof. In certain embodiments, the fabric manager component 510 is configured as an additional component which communicates with the baseboard component 512. In certain embodiments, the fabric manager component 510 functions as an arbitrator for peer-to-peer traffic between other switch devices of the host platform. In certain embodiments, the fabric manager component 510 consumes fewer PCIe links than an unbalanced inter-switch link. In certain embodiments, the fabric manager component 510 is implemented as an optional board which only adds cost to system configurations that need it.

In certain embodiments, the fabric manager component 510 includes a circuit board 520, a switching element 522, a plurality of HSIO connectors 524, a fabric manager component power input 526, or a combination thereof. In certain embodiments, the switching element 522 is physically and electrically coupled to the circuit board 520. In certain embodiments, each of the plurality of HSIO connectors 524 is physically and electrically coupled to the circuit board 520. In certain embodiments, fabric manager component power input 526 is physically and electrically coupled to the circuit board 520.

In certain embodiments, the switching element 522 includes a multi-link switch component. In certain embodiments, the multi-link switch component includes nine switch stations, each having sixteen lanes, which provides a 144-lane switch. In certain embodiments, the multi-link switch component includes a multi-lane PCIe switch. In certain embodiments, the multi-lane PCIe switch includes a 144-lane PCIe switch. In certain embodiments, the multi-lane PCIe switch includes nine switch stations, each having sixteen lanes, which provides a 144-lane PCIe switch.

In certain embodiments, the plurality of HSIO connectors 524 are positioned along peripheral edges of the circuit board 520. In certain embodiments, two HSIO connectors 524 are positioned along first peripheral edge of the circuit board 520. In certain embodiments, two HSIO connectors 524 are positioned along second peripheral edge of the circuit board 520. In certain embodiments, two HSIO connectors 524 are positioned along third peripheral edge of the circuit board 520. In certain embodiments, the plurality of HSIO connectors 524 include a plurality of HSIO switch connectors, a plurality of HSIO host connectors, or a combination thereof. In certain embodiments, a HSIO host connector and a HSIO switch connector are positioned along first peripheral edge of the circuit board 520. In certain embodiments, two HSIO switch connectors are positioned along second peripheral edge of the circuit board 520. In certain embodiments, a HSIO host connector and a HSIO switch connector are positioned along third peripheral edge of the circuit board 520.

In certain embodiments, each of the plurality of HSIO switch connectors is configured to connect the fabric manager component 510 to a respective HSIO switch. In certain embodiments, each respective HSIO switch is associated with one or more components of the component system. In certain embodiments, each respective HSIO switch is associated with four components of the component system. In certain embodiments, each of the plurality of HSIO host connectors is configured to connect the fabric manager component 510 to a respective host connector.

In certain embodiments, the plurality of HSIO switch connectors includes a first HSIO switch connector, a second HSIO switch connector, a third HSIO switch connector and a fourth HSIO switch connector. In certain embodiments, the first HSIO switch connector is configured to connect the fabric manager component 510 to a first HSIO switch. In certain embodiments, the second HSIO switch connector is configured to connect the fabric manager component 510 to a second HSIO switch. In certain embodiments, the third HSIO switch connector is configured to connect the fabric manager component 510 to a third HSIO switch. In certain embodiments, the fourth HSIO switch connector is configured to connect the fabric manager component 510 to a fourth HSIO switch.

In certain embodiments, the plurality of HSIO host connectors 524 include a first HSIO host connector and a second HSIO host connector. In certain embodiments, the first HSIO host connector is configured to connect the fabric manager component 510 to a first HSIO host component. In certain embodiments, the second HSIO host connector is configured to connect the fabric manager component 510 to a second HSIO host component. In certain embodiments, the first host component and the second host component include respective processors.

In certain embodiments, the baseboard component 512 includes a CPU/PCIe switch for communicating between a processor and a plurality of PCIe components. In certain embodiments, the baseboard component 512 includes a circuit board 530, a plurality of switching elements 532, a plurality of HSIO connectors 534, a plurality of component slots 536, or a combination thereof. In certain embodiments, the circuit board 530 includes circuitry for performing a CPU/PCIe switch function. In certain embodiments, the baseboard component 512 is included within a system board. In certain embodiments, the system board includes a system circuit board. In certain embodiments, the system circuit board includes one or more of a motherboard, a planar circuit board, a host processor module circuit board, a baseboard circuit board, or a combination thereof. In certain embodiments, the system board includes a plurality of slots. In certain embodiments, one or more of the plurality of slots 536 includes a CEM type slot.

In certain embodiments, each of the plurality of switching elements 532 includes a multi-link switch component. In certain embodiments, the multi-link switch component includes nine switch stations, each having sixteen lanes, which provides a 144-lane switch. In certain embodiments, the multi-link switch component includes a multi-lane PCIe switch. In certain embodiments, the multi-lane PCIe switch includes a 144-lane PCIe switch. In certain embodiments, the multi-lane PCIe switch includes nine switch stations, each having sixteen lanes, which provides a 144-lane PCIe switch. In certain embodiments, the plurality of HSIO switch elements includes a first HSIO switch element, a second HSIO switch element, a third HSIO switch element, and a fourth HSIO switch element.

In certain embodiments, the plurality of HSIO connectors 534 include a plurality of HSIO switch connectors. In certain embodiments, the plurality of HSIO switch connectors includes a first HSIO switch connector, a second HSIO switch connector, a third HSIO switch connector and a fourth HSIO switch connector. In certain embodiments, the first HSIO switch connector is configured to connect the baseboard component 512 between the fabric manager component 510 and the first HSIO switch element. In certain embodiments, the second HSIO switch connector is configured to connect the baseboard component 512 between the fabric manager component 510 and the second HSIO switch element. In certain embodiments, the third HSIO switch connector is configured to connect the baseboard component 512 between the fabric manager component 510 and the third HSIO switch element. In certain embodiments, the fourth HSIO switch connector is configured to connect the baseboard component 512 between the fabric manager component 510 and the fourth HSIO switch element.

In certain embodiments, each of the plurality of component slots 536 is configured to receive a respective component. In certain embodiments, the plurality of component slots 536 are configured to receive an array of components. In certain embodiments, the array of components includes a GPU module array.

In certain embodiments, the plurality of component slots 536 include a first set of component slots, a second set of component slots, a third set of component slots and a fourth set of component slots. In certain embodiments, each set of component slots includes a respective plurality of component slots. In certain embodiments, the first set of component slots includes a first set, first component slot, a first set, second component slot, a first set, third component slot and a first set, fourth component slot. In certain embodiments, the second set of component slots includes a second set, first component slot, a second set, second component slot, a second set, third component slot and a second set, fourth component slot. In certain embodiments, the third set of component slots includes a third set, first component slot, a third set, second component slot, a third set, third component slot and a third set, fourth component slot. In certain embodiments, the fourth set of component slots includes a fourth set, first component slot, a fourth set, second component slot, a fourth set, third component slot and a fourth set, fourth component slot.

In certain embodiments, the first HSIO switch element communicates with the first set of component slots. In certain embodiments, the second HSIO switch element communicates with the second set of component slots. In certain embodiments, the third HSIO switch element communicates with the third set of component slots. In certain embodiments, the fourth HSIO switch element communicates with the fourth set of component slots. In certain embodiments, the first HSIO switch connector is configured to connect the fabric manager component 510 to the first set of component slots via the first HSIO switch element. In certain embodiments, the second HSIO switch connector is configured to connect the fabric manager component 510 to the second set of component slots via the second HSIO switch element. In certain embodiments, the third HSIO switch connector is configured to connect the fabric manager component 510 to the third set of component slots via the third HSIO switch element. In certain embodiments, the fourth HSIO switch connector is configured to connect the fabric manager component 510 to the fourth set of component slots via the fourth HSIO switch element.

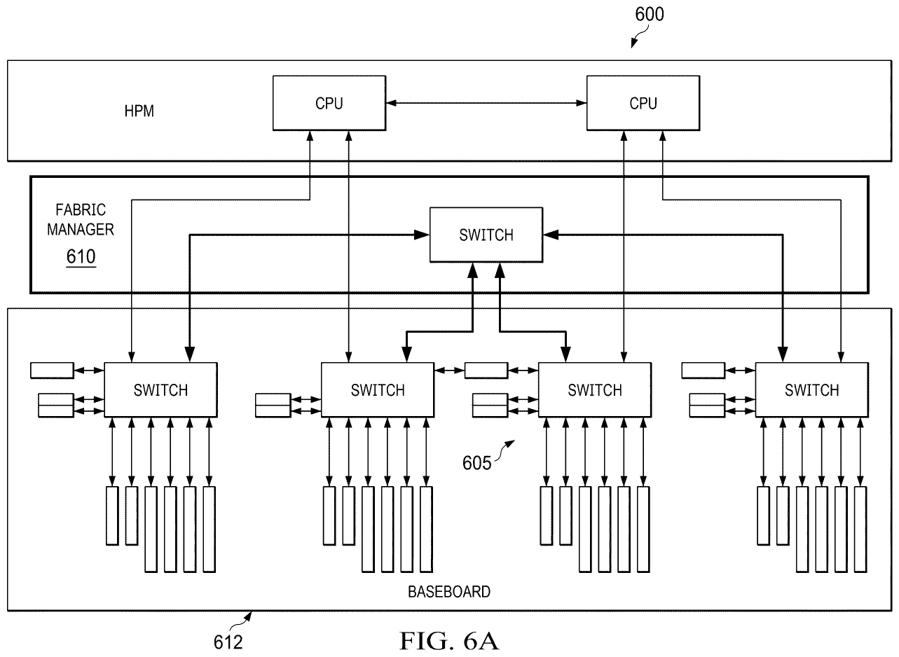

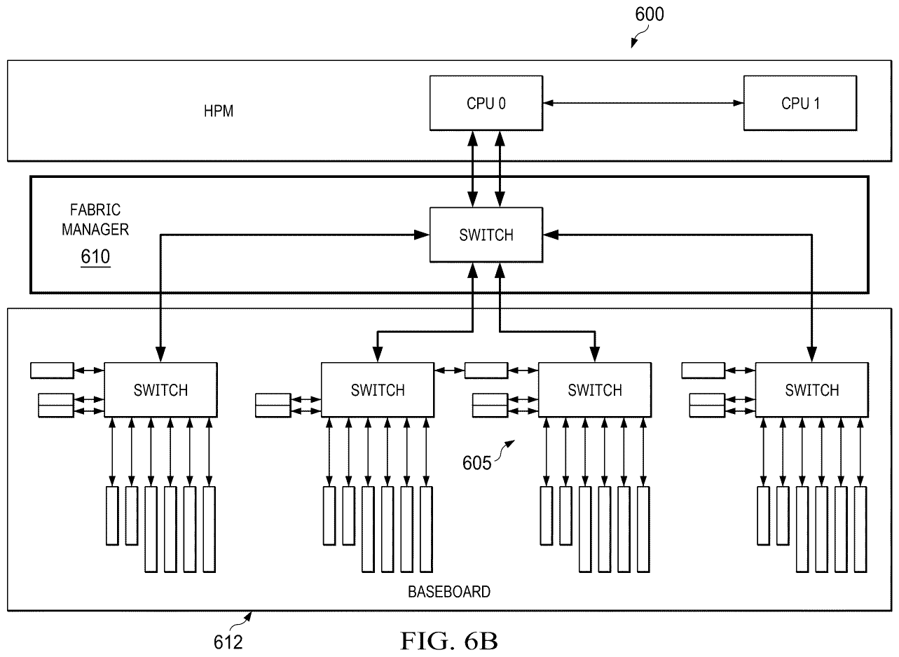

FIGS. 6A and 6B, generally referred to as FIG. 6, show schematic views of a component system 600 having a fabric manager system. More specifically, FIG. 6A shows a schematic view of a component system 605 having a fabric manager system 610 which is configured in a point to point configuration. FIG. 6B shows a schematic view of a component system 600 having a fabric manager system which is configured in a single root configuration. In certain embodiments, the component system 600 corresponds to component system 150. In certain embodiments, the fabric manager system is organized in a tree topology implementation, while performing as a mesh connected topology.

In certain embodiments, the fabric manager system includes a fabric manager component 610, a baseboard component 612, or a combination thereof. In certain embodiments, the fabric manager component 610 is configured as an additional component which communicates with the baseboard component 612. In certain embodiments, the fabric manager component 610 functions as an arbitrator for peer-to-peer traffic between other switch devices of the host platform. In certain embodiments, the fabric manager component 610 consumes fewer PCIe links than an unbalanced inter-switch link. In certain embodiments, the fabric manager component 610 is implemented as an optional board which only adds cost to system configurations that need it.

Referring now to FIG. 6A, when the fabric manager system is configured on a point to point configuration, the fabric manager component 610 is configured to operate solely as an internal point to point traffic manager.

Referring now to FIG. 6B, when the fabric manager system is configured in a single root configuration, the fabric manager component 610 is configured to operate as a host to component slot traffic manager as well as an internal point to point traffic manager.

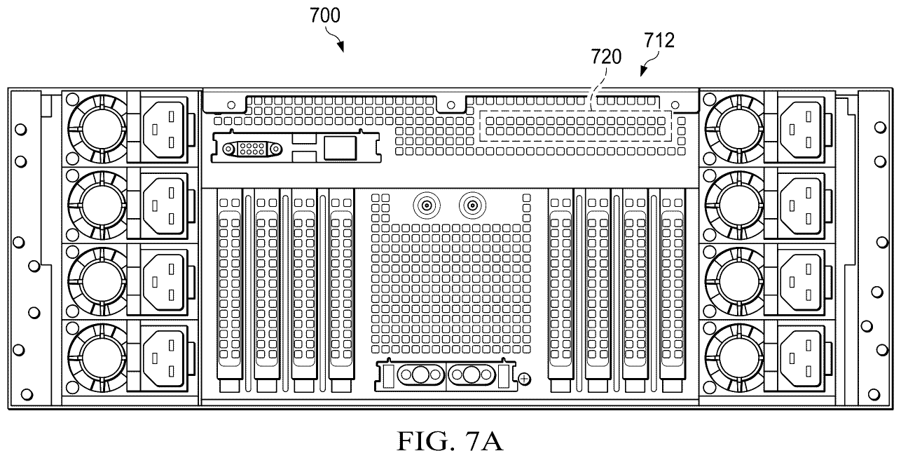

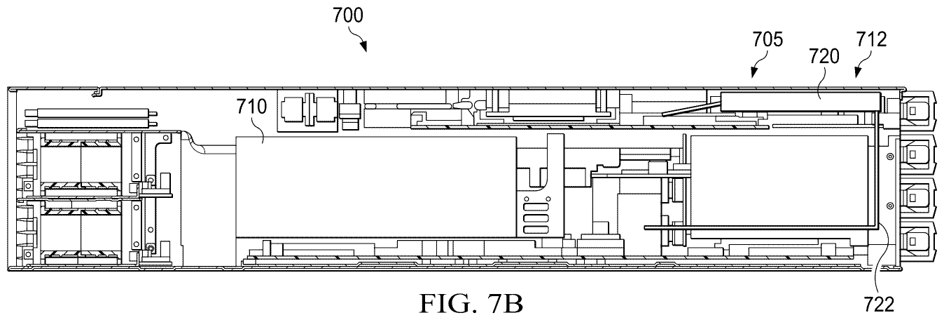

FIGS. 7A and 7B, generally referred to as FIG. 7, show diagrammatic views of an information handling system chassis 700 having a component system 705. More specifically, FIG. 7A shows a diagrammatic rear view of an information handling system chassis having a component fabric manager system 720. FIG. 7B shows a diagrammatic side view of an information handling system chassis having a component fabric manager system 705. In certain embodiments, the component system 705 corresponds to component system 150.

In certain embodiments, the component system 705 includes a component array 710 and a fabric manager system 712, providing a component array system. As used herein, an array broadly refers to a plurality of information handling system components which are physically arranged substantially (i.e., +/−20%) parallel with each other. In certain embodiments, the component array 710 includes a GPU module array. In certain embodiments, the fabric manager system 712 includes a fabric manager component 720. In certain embodiments, the GPU module array includes a plurality of GPU modules mounted in a CEM orientation.

In certain embodiments, the information handling system chassis is configured to provide a location to mechanically house the fabric manager component 720. In certain embodiments, the fabric manager system includes cables 722 for routing communication to and from the fabric manager component 720. In certain embodiments, the information handling system chassis is configured to provide a location to mechanically route the cables 722 to and from the fabric manager component 720.

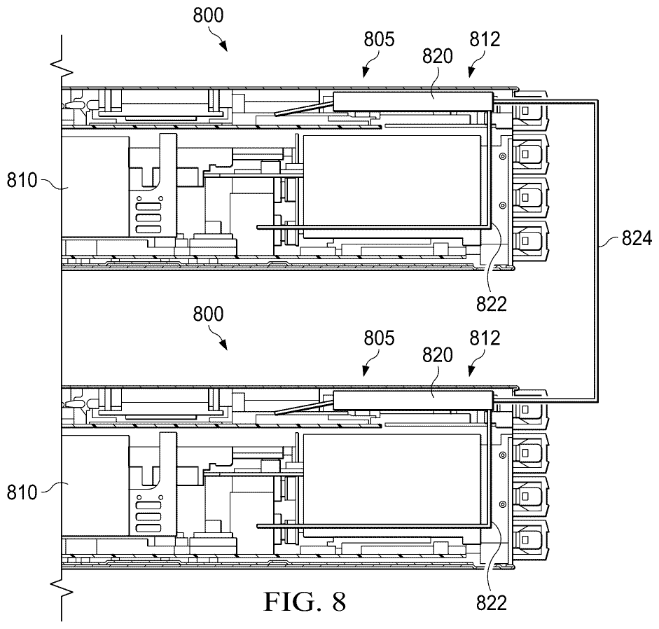

FIG. 8 shows a diagrammatic view of a plurality of information handling system chassis 800 having respective component systems 805. More specifically, FIG. 8 shows a diagrammatic side view of a plurality of information handling system chassis 800 having respective component systems 805. In certain embodiments, each component system 805 corresponds to component system 150.

In certain embodiments, each component system 805 includes a component array 810 and a fabric manager system 812, providing a respective component array system. In certain embodiments, one or more component arrays 810 include a GPU module array. In certain embodiments, one or more fabric manager systems 812 include a fabric manager component 820. In certain embodiments, the GPU module array includes a plurality of GPU modules mounted in a vertical orientation.

In certain embodiments, each information handling system chassis is configured to provide a location to mechanically house the fabric manager component 820. In certain embodiments, the fabric manager system includes cables 822 for routing communication to and from the fabric manager component as well as cables 824 for routing communication to and from fabric manager components of other systems. In certain embodiments, the information handling system chassis is configured to provide a location to mechanically route the cables 822 to and from the fabric manager component 820.

In certain embodiments, the fabric manager components may be configured to operate in a multi host environment where two or more information handling systems communicate via respective fabric manager components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A fabric manager component of a fabric manager system for an information handling system, comprising:
a circuit board, the board comprising a printed circuit board;
a switching element mounted on the circuit board; and
a plurality of high speed input/output connectors mounted on the board, the plurality of high speed input/output connectors being coupled to the switching element, the switching element and the plurality of high speed connectors being configured to enable the fabric manager component to function as an arbitrator for peer-to-peer traffic between other switch devices of the information handling system.

2. The fabric manager component of claim 1, wherein:
the switching element includes a multi-link switch component.

3. The fabric manager component of claim 2, wherein:
the multi-link switch component includes a multi-lane PCIe switch.

4. The fabric manager component of claim 1, wherein:
the plurality of high speed input/output connectors are positioned along peripheral edges of the circuit board.

5. The fabric manager component of claim 1, wherein:
the plurality of high speed input/output connectors include a plurality of high speed input/output switch connectors.

6. The fabric manager component of claim 5, wherein:
the plurality of high speed input/output connectors further include a plurality of high speed input/output switch connectors.

7. A component system for use in an information handling system comprising:
an array of components, the array of components comprising a plurality of components; and,
a fabric manager system, the fabric manager system comprising:
a baseboard component, the baseboard component comprising a printed circuit board and a plurality of switch elements; and,
a fabric manager component communicating with the baseboard component, the fabric manager component comprising:
a circuit board, the board comprising a printed circuit board;
a switching element mounted on the circuit board; and
a plurality of high speed input/output connectors mounted on the board, the plurality of high speed input/output connectors being coupled to the switching element, the switching element and the plurality of high speed connectors being configured to enable the fabric manager component to function as an arbitrator for peer-to-peer traffic between other switch devices of the information handling system.

8. The component system of claim 7, wherein:
the switching element includes a multi-link switch component.

9. The component system of claim 8, wherein:
the multi-link switch component includes a multi-lane PCIe switch.

10. The component system of claim 7, wherein:
the plurality of high speed input/output connectors are positioned along peripheral edges of the circuit board.

11. The component system of claim 7, wherein:
the plurality of high speed input/output connectors include a plurality of high speed input/output switch connectors.

12. The component system of claim 11, wherein:
the plurality of high speed input/output connectors further include a plurality of high speed input/output switch connectors.

13. A system comprising:
a chassis;
a processor contained within the chassis;
a data bus coupled to the processor; and,
an array of components contained within the chassis, the array of components comprising a plurality of components; and,
a fabric manager system, the fabric manager system comprising:
a baseboard component, the baseboard component comprising a printed circuit board and a plurality of switch elements; and,
a fabric manager component communicating with the baseboard component, the fabric manager component comprising:
a circuit board, the board comprising a printed circuit board;
a switching element mounted on the circuit board; and
a plurality of high speed input/output connectors mounted on the board, the plurality of high speed input/output connectors being coupled to the switching element, the switching element and the plurality of high speed connectors being configured to enable the fabric manager component to function as an arbitrator for peer-to-peer traffic between other switch devices of the information handling system.

14. The system of claim 13, wherein:
the switching element includes a multi-link switch component.

15. The system of claim 14, wherein:
the multi-link switch component includes a multi-lane PCIe switch.

16. The system of claim 13, wherein:
the plurality of high speed input/output connectors are positioned along peripheral edges of the circuit board.

17. The system of claim 13, wherein:
the plurality of high speed input/output connectors include a plurality of high speed input/output switch connectors.

18. The system of claim 17, wherein:
the plurality of high speed input/output connectors further include a plurality of high speed input/output switch connectors.
